(19) United States
(12) Patent Application Publication
(10) Pub. No.: US 2003/0204436 A1
(43) Pub. Date: Oct. 30, 2003

(54) Survey data gathering

(76) Inventors: Joerg Flender, Wiesloch (DE); Christopher Paul Fastabend, Mannheim (DE); Bernd R. Lehnert, Neustadt (DE)

Correspondence Address: MARK D. KIRKLAND, Fish & Richardson P.C., P.A., Suite 3300, 60 South Sixth Street, Minneapolis, MN, 55402, US

(21) Appl. No.: 10/137,114

(22) Filed: Apr. 30, 2002

(51) Int. Cl. G06F 17/60

(52) U.S. Cl. 705/10

(57) ABSTRACT

A system, method and computer-readable medium for collecting and integrating survey data sets. Certain illustrative embodiments can be advantageously employed to collect and integrate customer surveys distributed at conferences. In other embodiments, a system automatically generates lead objects reflecting the survey response data.

### TECHNICAL FIELD

The invention relates to the collection and processing of data sets such as survey responses and customer profiles.

### BACKGROUND

Companies often gather information in an attempt to learn more about their market, customers, potential customers, and new business opportunities. The gathered information can be utilized to design and direct marketing or sales activities. Such information can be generated and gathered through customer surveys. The surveys can present various questions about a customer, its needs, its future business plans, its likes, its dislikes, and its opinions about various topics of interest to the surveyor. Surveys are often issued to the parties identified on a lead list or database maintained by the surveyor.

Surveys can be administered in a variety of ways. Surveys may be presented on paper and request the recipient to provide prose answers to various questions. Alternately, a Scantron™ or similar form may be provided, which is suitable for reading by automated equipment. In both the foregoing approaches, large volumes of paper must be printed, handled, organized, analyzed, and processed.

Various electronic data gathering techniques have also been deployed. Computerized surveys may be executed at kiosks or the like. Surveys may also be disseminated by e-mail or presented in HTML format on a website sponsored or maintained by the surveyor. Such techniques can reduce the cost associated with production and dissemination of the survey and the collection of the survey information.

Typically, electronic survey systems download survey information into a database and map survey responses to one or more entries in a lead database that includes entries detailing the identities of the survey recipients. The resulting databases and database relations must then be mined to extract a report concerning the survey results. Such an approach can require the maintenance of three separate databases, one global customer database, one lead database (listing the survey recipients), and one survey response database. The various databases must also include the mapping information associating the entries of each. In such a system further, oftentimes manual, processing is necessary to classify or categorize the leads based on the survey responses.

### SUMMARY

The invention is directed to a system, method, and computer-readable medium for generating a data gathering file such as a form, receiving responses thereto, and generating an object or file that includes data reflecting the responses and the identity of the responder. In certain illustrative embodiments, the invention can be advantageously employed to create a survey object tagged with a customer identifier and to automatically, upon receipt of survey response information, generate a lead object that includes customer information, survey response information, and an attribute code that serves to classify or qualify the lead object. In some embodiments, the lead objects can be automatically, immediately, and selectively transmitted the appropriate representatives, such as call centers or sales representatives.

Various embodiments of the invention can be implemented to realize one or more of the following advantages. In certain embodiments, storage space and processor demand are reduced by virtue of a simplified data model in which a lead object is not created until after survey data is collected. In other embodiments, the system permits efficient and automatic qualification of the lead object so that it can be immediately routed to the appropriate entity for follow-up activities.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system for gathering information embodying the invention;

FIG. 2 is a flow chart of steps that may be performed by a system for gathering information embodying the invention; and

FIG. 3 is a block diagram of another system for gathering information embodying the invention.

Like reference symbols in the various drawings indicate like elements.

### DETAILED DESCRIPTION OF ILLUSTRATIVE EMBODIMENTS

Certain embodiments described herein can be used to present a survey and automatically collect the responses and generate lead objects for selective transmission to appropriate company representatives, such as call center workers or sales representatives. In one preferred embodiment, a survey recipient can be electronically identified at an event, such as a conference, contact information associated with the recipient can be either created or retrieved from a customer database, an extensible markup language (XML) survey form object can be created and coded with a customer identifier, the survey form can be downloaded to an input device such as a personal digital assistant, the completed survey form can be uploaded to a lead engine, the lead engine can create a lead object and import the customer information into the lead object, a qualification module can generate an attribute value (such as time-sensitivity) that can be encoded into the lead object, and the lead object can be selectively transmitted to recipients such as a sales representatives and call centers based upon the qualification value.

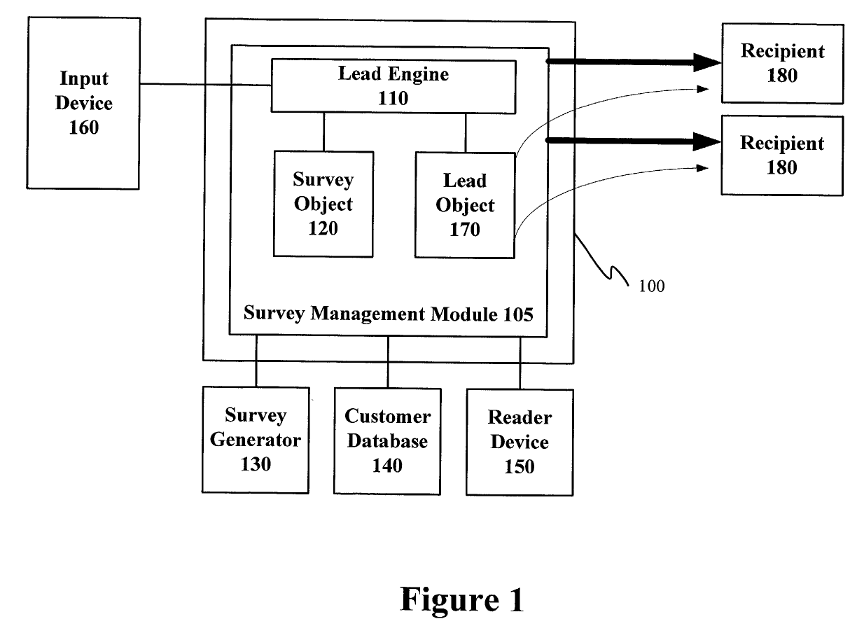

FIG. 1 shows a networked system that can be used to implement the techniques discussed above. FIG. 1 shows a platform 100 that can be any suitable computing environment, such as a network server, a node in a local network, a laptop computer wirelessly connected to the appropriate devices, etc. The platform 100 may include a survey management module 105 that manages the survey data gathering process. The survey management module 105 is operatively connected with a survey generator 130, a customer database 140 and a reader device 150. The survey generator 130, customer database 140 and reader device 150 are shown as residing on platforms separate from platform 100, but in other embodiments one or more of them may share the platform 100 with the survey management module 105.

The survey management module 105 contains a lead engine 110 that prepares surveys, transmits them for distribution, and gathers the responses. Survey generator 130 may upload queries, questions, etc. to the lead engine 110 to be included in survey object 120. The lead engine 110 transmits the survey object 120 to an input device 160 where a user may review the survey and submit a response.

The lead engine 110 may communicate with a database having information on entities, such as customer database 140. The survey object 120 can include a recipient identifier for identification and processing of survey responses. The lead engine 110 may, for example, search the customer database 140 for information to use as a recipient identifier in a survey.

In some embodiments, individuals taking the survey may identify themselves to the system through reader device 150. For example, if the survey is distributed at a conference, the reader device 150 may be a scanner that reads an attendee registration string from a card or a badge carried by the attendee. The lead engine 110 may use all or part of the scanned information to generate a recipient identifier to be included in the survey object 120. In some embodiments, reader device 150 may be a sub-component of input device 160.

The lead engine 110 sends the survey object 120 to the input device 160 for response by a recipient. The transmission of the survey and reception of a response may occur on a hardwire network connection, a wireless network, direct serial link from a keyboard, or other known means. In certain embodiments, the input device can reside on a personal digital assistant (“PDA”) and the survey response data can be transmitted to the lead engine 110 by IR connection, an RF network, or via a cradle connection on a LAN connected to platform 100.

The input device 160 can use survey object 120 to display the survey in human-readable form on a display. The recipient may review the survey and respond by entering information on the input device 160. The response from input device 160 may be transmitted without the survey object and the queries. Alternatively, the response may include part or all of the questions or queries of the survey object.

The information transmitted by the input device 160 can include a survey value file the content of which indicates the answers given by a recipient to various survey questions. The survey value file can be coded with a recipient identifier which uniquely identifies the person who provided the answers reflected in the survey value file. The recipient identifier can be used to map the survey value file to one or more entries in the customer database 140.

The lead engine 110 may create a lead object 170 reflecting the survey response data and the identity of the survey recipient. In various embodiments, the lead object generation may optionally be conducted immediately and nearly instantaneously upon receiving the survey response. In one example, an HTML survey is received electronically on a web-based platform and automatically transmitted to the lead engine 110, which immediately creates the lead object 170.

The lead object 170 may be forwarded to one or more recipients 180. For example, the lead object may be forwarded to a group or person within a company for following up on the lead. As another example, the lead may be forwarded for qualification to determine whether the lead is time-sensitive and should be attended to promptly.

In one embodiment, the lead object 170 is qualified by statistically correlating the response data with one or more attributes such as immediate interest in product purchase and the budget size for a purchase. Any suitable method, such as text string searching, Boolean searching, fuzzy logic, artificial intelligence, etc. may be used to determine if and to what extent the survey response correlates with the attribute(s). After the lead is qualified, the lead engine 110 may route the lead object based on an attribute value reflecting the statistical correlation.

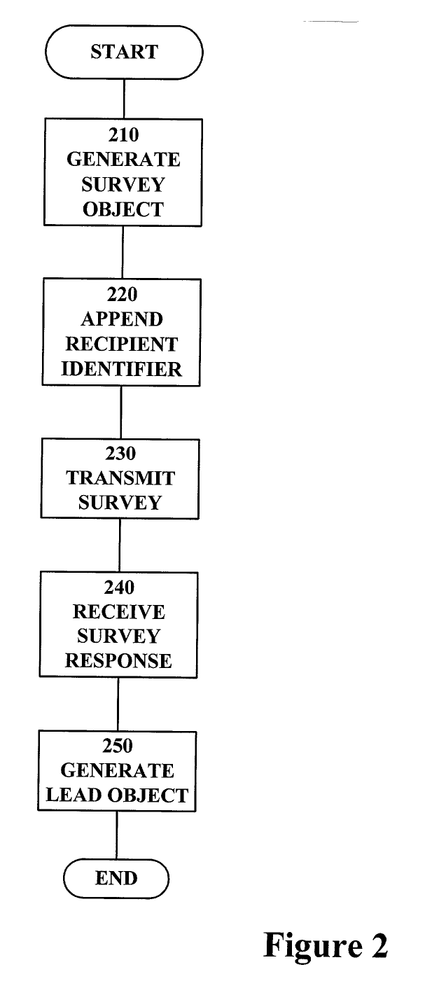

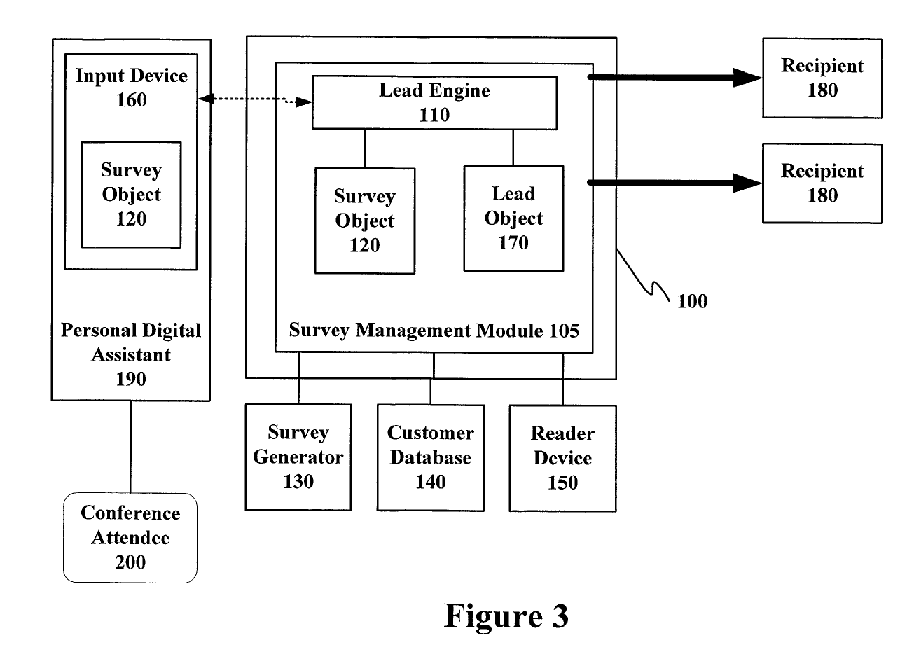

An exemplary operation of a system for survey data gathering will be described in more detail with reference to the flow chart in FIG. 2. Reference will also be made to the exemplary system embodiment in FIG. 3. Some components in the FIG. 3 system that have the same reference numerals as in FIG. 1 will not be specifically described here.

In step 210, the lead engine 110 obtains one or more survey queries from the survey generator 130 and generates the survey object 120 which may be distributed to existing and potential customers of an enterprise at a conference. The enterprise may input queries into survey generator 130 to tailor the survey to the enterprise's products and services.

The lead engine appends the recipient identifier to the survey object in step 220 for identifying the received responses. For example, when the survey object 120 is represented in an XML format, the lead engine may embed the attendee identifier in the XML content of the survey object.

The recipient identifier may be a registration string for the attendee at the conference. In such an example, the enterprise may sometimes obtain the string in advance, and can match a record of the attendee's company with the corresponding record in customer database 140. For example, the customer database 140 may be searched for entries matching the registration string. In other examples, the lead engine 110 may assign a recipient identifier when it downloads the survey to the input device.

In some embodiments, the recipient identifier is contained in a card or badge carried by the attendee. The survey download to the input device may then be initiated by having reader device 150 scan the recipient identifier from the card or badge. In such embodiments, the card or badge may contain the recipient identifier stored in any machine-readable form, such as visually, magnetically or electronically.

In step 230, the lead engine transmits the survey object 120 to the input device 160 which in this embodiment is contained in a PDA 190. The attendee may respond to the survey by entering information into the PDA and uploading the information to the lead engine 110. The lead engine can receive survey response data in realtime if there is an online connection with the PDA. Alternatively, the attendee may enter data into the PDA while being offline and subsequently connect to the lead engine to upload the response.

In step 250, the lead engine generates the lead object after receiving the response data. In some embodiments, the lead object may contain information that reflects the survey response data, such as an average of several response values from the attendee. As another example, the lead object may include all or part of the response data, such as the part of the response data that relates to the attendee's interest in a certain product.

The lead object 170 may be forwarded to one or more recipients 180 for further processing. This may, for example, involve qualification by statistical correlation to determine an attribute value, manual interaction and analysis in a call center, or forwarding the lead object to a sales department or sales representative for follow-up.

Those skilled in the art will recognize that the aforementioned techniques and systems can be implemented in a variety of advantageous manners. The input device can be any suitable customer interface, such as web-based surveys, PDAs, cell phones implementing voice driven surveys, and personal computers of all varieties. The survey object can have any desired format, including but not limited to XML, HTML, a visual basic compatible format, and rich text format. Any number of questions can be posed in the survey and answers can be selected from options presented in drop-down boxes or check boxes, answers can be entered manually, etc. The lead engine can operate on one or multiple platforms. For instance, the lead engine may be distributed on various network platforms for generating and transmitting the survey object and receiving the response data. The various components described may communicate or interact via any suitable means, such as e-mail, hardwire connection, wireless network, cellular network, or the like. The survey objects can be transmitted to any desired number of recipients in any order or combination.

It will be further understood that the foregoing techniques can be implemented to gather data sets of any origin. For example, an embodiment of a survey data gathering system may be used to gather data from job applicants who visit the enterprise's premises. As another example, a system may be used at a job fair to gather data from job applicants.

A number of embodiments of the invention have been described. Nevertheless, it will be understood that various modifications may be made without departing from the spirit and scope of the invention. Accordingly, other embodiments are within the scope of the following claims.

What is claimed is:

1. A method of gathering survey data, comprising:
providing a survey form that includes one or more queries;
appending the survey form with a recipient identifier;
transmitting the survey form to an input device;
receiving survey response data from the input device; and
generating a lead file that includes information reflecting the survey response data and the recipient's identity.

2. The method of claim 1, further comprising generating the survey form.

3. The method of claim 1, further comprising receiving a recipient identification string and searching a database for contact information associated with the recipient identification string.

4. The method of claim 3, wherein the recipient identifier is associated with an entry in the database.

5. The method of claim 1, wherein the input device is a personal digital assistant.

6. The method of claim 1, wherein the survey response data is a data file or object including values representing responses to questions on the survey form.

7. The method of claim 1, further comprising the step of routing the lead file based upon an attribute value which is generated by a statistical correlation of the survey response data.

8. The method of claim 1, wherein the recipient identifier is encoded in the survey form.

9. The method of claim 1, wherein the survey form is transmitted to the input device during an event, further comprising assigning the recipient identifier to the recipient.

10. The method of claim 1, wherein the survey form comes from an enterprise and the survey form is transmitted to the input device during a conference attended by at least one customer or potential customer of the enterprise.

11. The method of claim 1, wherein the survey form is transmitted to the input device during an event, and wherein the recipient identifier is encoded visually, magnetically or electronically in a card or badge.

12. The method of claim 1, wherein the survey form is transmitted to the input device during an event, and wherein the survey response data is transmitted from the input device after the event.

13. A system for gathering survey data, comprising:
a customer database;
a survey form that includes one or more queries and an associated recipient identifier derived from the customer database;
a lead engine to append the recipient identifier to the survey form, transmit the survey form to an input device associated with a customer in the customer database, receive survey response data from the input device, and generate a lead file that includes information reflecting the survey response data and information concerning the recipient's identity.

14. The system of claim 13, further comprising a recipient identification string to be used for searching a database for contact information.

15. The system of claim 14, wherein the recipient identifier is associated with an entry in the database.

16. The system of claim 13, wherein the input device is a personal digital assistant.

17. The system of claim 13, wherein the survey response data is a data file or object including values representing responses to questions on the survey form.

18. The system of claim 13, wherein the lead engine routes the lead file based upon an attribute value which is generated by a statistical correlation of the survey response data.

19. The system of claim 13, wherein the recipient identifier is encoded in the survey form.

20. The system of claim 13, wherein the lead file includes at least part of the survey response data.

21. Computer-readable medium having stored thereon instructions that when executed perform the following functions:
provides a survey form that includes one or more queries;
appends the survey form with a recipient identifier;
transmits the survey form to an input device;
receives survey response data from the input device; and
generates a lead file that includes information reflecting the survey response data and the recipient's identity.

22. The computer-readable medium of claim 21, further comprising the function generating the survey form.

23. The computer-readable medium of claim 21, further comprising the function receiving a recipient identification string and searching a database for contact information associated with the recipient identification string.

24. The computer-readable medium of claim 21, further comprising the function associating the recipient identifier with an entry in the database.

25. The computer-readable medium of claim 21, wherein the input device is a personal digital assistant.

26. The computer-readable medium of claim 21, wherein the survey response data is a data file or object including values representing responses to queries on the survey form.

27. The computer-readable medium of claim 21, further comprising the function routing the lead file based upon an attribute value which is generated by a statistical correlation of the survey response data.

28. The computer-readable medium of claim 21, wherein appending the recipient identifier comprises encoding the recipient identifier in the survey form.
